(19) United States
(12) Patent Application Publication
(10) Pub. No.: US 2005/0252522 A1
(43) Pub. Date: Nov. 17, 2005

(54) Megasonic cleaning with obliquely aligned transducer

(76) Inventors: Kenneth C. Struven, San Carlos, CA (US); Michael B. Olesen, Yorba Linda, CA (US)

Correspondence Address: Harris Zimmerman;Law Offices of Harris Zimmerman, Suite 710, 1330 Broadway, Oakland, CA, 94612, US

(21) Appl. No.: 10/844,138

(22) Filed: May 11, 2004

(51) Int. Cl. B08B 3/12

(52) U.S. Cl. 134/1; 134/166 R

(57) ABSTRACT

A method and apparatus for megasonic bath cleaning of wafers employs a megasonic resonator that is directed obliquely toward the front, active surface of the wafer, so that higher acoustic energy levels may be used without causing structural damage to the wafer. In one embodiment four transducers are coupled to a resonating plate, the four transducers being spaced apart to uniformly radiate separate portions of the wafer that total a ¼ portion of the wafer surface. When the wafer is rotated, the wafer receives equal megasonic power across the entire surface. In a further embodiment, a resonating plate is driven by an acoustic transducer at an angle to the wafer and coupled to a refracting plate to result in an off-normal axis impingement angle. In another embodiment, a resonating plate is translated radially with respect to a wafer. The radiating surface of the plate may be rotated 0°-10° from normal to radiate obliquely to the wafer surface.

### CROSS-REFERENCE TO RELATED APPLICATIONS

none

### FEDERALLY SPONSORED RESEARCH

Not applicable.

### SEQUENCE LISTING, ETC ON CD

Not applicable.

### BACKGROUND OF THE INVENTION

1. Field of the Invention

This invention relates to a method and apparatus for megasonic cleaning and, more particularly, to the use of at least one acoustic transducer aligned obliquely to the surface of a wafer undergoing cleaning.

2. Description of Related Art

In the production and manufacture of electrical components, it is a recognized necessity to be able to clean, etch or otherwise process substrates to an extremely high degree of cleanliness and uniformity. Various cleaning, etching, or stripping processes may be applied to the substrates a number of times in conjunction with the manufacturing steps to remove particulates, predeposited layers or strip resist, and the like.

One cleaning process that is often employed involves ultrasonic cleansing; that is, the application of high amplitude ultrasonic energy to the substrates in a liquid bath. More specifically, the ultrasonic energy is generally, but not limited to, the range of 0.60-10.00 MHz, and the process is termed megasonic cleaning. The liquid bath may comprise deionized water, standard cleaning solutions, dilute HF, sulfuric, phosphoric, organic strip, or the like. The amplitude and the length of time of application of the sonic energy are generally well known in the prior art.

In the process of cleaning large single substrates, it is common practice to immerse the substrate in a tank filled with an appropriate solution, and to immerse a megasonic transducer in close proximity to the substrate, the acoustic output being coupled to the surface of the substrate by the solution. The output axis of the transducer is typically aligned perpendicular to the surface of the wafer, ostensibly to maximize the cleaning effect. The wafer may be rotated to utilize a transducer smaller in output area than the wafer, and to distribute the sonic energy uniformly over the surface undergoing cleaning.

It has been observed that although a perpendicular alignment of the megasonic transducer is most effective in cleaning, it is also responsible for causing structural damage to the wafer that reduces the yield of the wafer. Thus there is a paradox: the more acoustic power used to achieve the highest possible cleanliness, the greater the chance that the substrate will suffer structural damage.

### BRIEF SUMMARY OF THE INVENTION

The present invention generally comprises a method and apparatus for megasonic cleaning of wafers and the like. A salient aspect of the invention is that the megasonic energy is directed obliquely toward the front surface of the wafer, so that higher acoustic energy levels may be used without causing structural damage to the wafer. The front surface is defined as the active device side of the wafer, as opposed to the non-active backside of the wafer.

The invention relates in one aspect to single wafer megasonic cleaning baths in which the wafer is held in close proximity to a megasonic resonating assembly and rotated to distribute the megasonic energy uniformly and circulate the cleaning solution evenly. In general, the wafer is held so that the wafer is facing toward the surface of the transducer resonating plate. It is coupled acoustically to this plate by a fluid that flows from a port near the center of the plate toward the wafer. At least one megasonic transducer is secured to the bottom surface to the resonating plate, which is tuned (in terms of mass, size and thickness) to pass the megasonic energy of the frequency of the transducer. It is significant that the transducer output face is disposed at an defined angle to the upper radiating surface of the resonating plate. Allowing the megasonic energy to pass up through the top plate at an angle and strike the acoustically coupled front surface of the wafer at an angle prevents device structure damage in the wafer that may otherwise occur in prior art systems at the power levels and frequency of the invention.

In one embodiment the invention provides four transducers coupled to the resonating plate, the four transducers being sized and distributed so that the four transducers uniformly radiate separate portions of the wafer that together total a ¼ portion of the wafer surface. When the wafer is rotated, that uniformly distributed energy is swept across the wafer surface to irradiate the wafer surface with equal megasonic power across the entire surface. This arrangement permits the use of maximum sonic power without focusing excessive sonic power at any one moment at any portion of the rotating wafer. It offers a more uniform distribution of temperature by having the fluid, which is pumped through at least one port in the resonating plate, aid in the control of the temperature of the solvent fluid between the wafer and the resonating plate. In one embodiment the incoming solvent is directed to cool the transducers before entering the wafer/resonating plate boundary space.

In a further embodiment, a resonating plate is driven by an acoustic transducer that is arranged to radiate the wafer at an angle of approximately 1-10°. The transducer is disposed at an angle of approximately 30° to the wafer and coupled to a refracting plate formed of aluminum or the like. The refraction of the sound energy, described by Snell's Law, results in the 7° angle of impingement.

In another embodiment, a resonating plate is supported on a translating assembly that enables the plate to move radially with respect to a wafer. The radiating surface of the plate is generally parallel, but may be rotated at much as 10° from parallel to deliver the megasonic energy obliquely to the wafer surface. Thus the angle may be adjusted to optimize the megasonic cleansing effect at the surface of the wafer.

The concept of beaming megasonic energy at a non-normal angle to the front surface undergoing cleaning may be extended to batch cleaning of wafers. One or more transducers may be disposed in a batch processing tank in which a plurality of wafers are immersed while being supported in a cassette or the like. The transducer(s) may be mounted on the sides and/or bottom of the tank and directed to radiate megasonic energy at an oblique angle to the surfaces of the wafers.

### BRIEF DESCRIPTION OF THE DRAWING

FIG. 1 is a schematic view of a fundamental aspect of prior art megasonic bath cleaning systems.

FIG. 2 is a schematic view as in FIG. 1, showing the novel angular relationship of the megasonic transducer to a cleaning surface in the present invention.

FIG. 3 is a graphic representation of Damage Threshold versus Angle of Incidence for megasonic sound energy impinging on a semiconductor wafer.

FIG. 4 is a graphic representation of Damage Threshold versus Frequency and Angle of Incidence for megasonic energy impinging on a semiconductor wafer.

FIG. 5 is a cross-sectional elevation of one embodiment of a megasonic resonator assembly of the invention.

FIG. 6 is a plan view of the resonating plate assembly of the embodiment shown in FIG. 5.

FIG. 7 is a partially cross-sectioned elevation of the megasonic resonator assembly of FIGS. 5 and 6 installed in a chuck.

FIG. 8 is a side elevation of the megasonic resonator assembly of FIGS. 5 and 6 installed in a chuck.

FIG. 9 is a partially cutaway side elevation of a further embodiment of a resonator assembly supported in a chuck structure.

FIG. 10 is a plan view of the resonator assembly depicted in FIG. 9.

FIG. 11 is a plan view of another embodiment of a resonator plate in accordance with the present invention.

FIG. 12 is a cross-sectional elevation of the resonator plate of FIG. 11, taken along line 12-12.

FIG. 13 is a cross-sectional elevation of the resonator plate of FIGS. 11 and 12, taken along line 13-13.

FIGS. 14 and 15 are schematic elevations showing a translatable resonator assembly and process tank, in the disengaged and engaged dispositions, respectively.

FIGS. 16 and 17 are partially cross-sectional end views showing the resonator assembly of the device of FIGS. 14 and 15 in normal and offset dispositions.

### DETAILED DESCRIPTION OF THE INVENTION

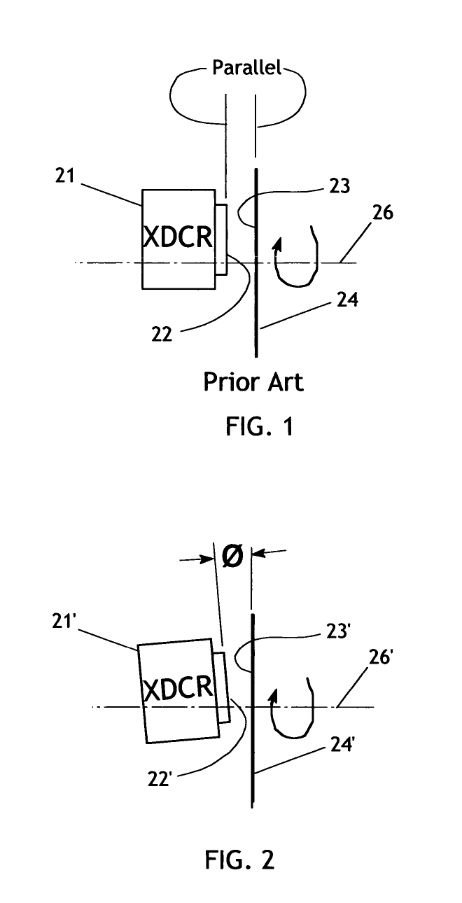

The present invention generally relates to wafer megasonic cleaning baths in which the wafer is held in close proximity to a megasonic resonating assembly and rotated to apply the megasonic energy to the wafer. As shown in FIG. 1, in a typical prior art megasonic cleaning bath a transducer 21 has a sound emitting surface 22. The surface 22 is generally parallel to and facing the front side, or active surface 23 of a wafer 24 that is undergoing cleaning in the bath. The wafer 24 (or the transducer 21) may be rotated about an axis 26 normal to both the surface 22 and the wafer surface 23 to sweep the acoustic output over the adjacent surface of the wafer. This relationship is generally believed to maximize the cleansing effect of the acoustic energy. However, it is also recognized that high acoustic power levels beamed at an angle normal to the wafer surface can damage ultra-sensitive semiconductor device structures, such as poly gate stacks at even low power densities. One approach to reducing this damage has been to reduce the megasonic power, or even turn it off altogether. Yet another approach has been to project the megasonic power toward the backside, or inactive surface of the wafer, causing an attenuation of sonic energy as it passes through the wafer. These approaches result in increased contamination on the wafer surface and concomitant losses in device yield from the wafer, as well as damage in the latter approach due to non-uniformities in sonic transmission through the wafer.

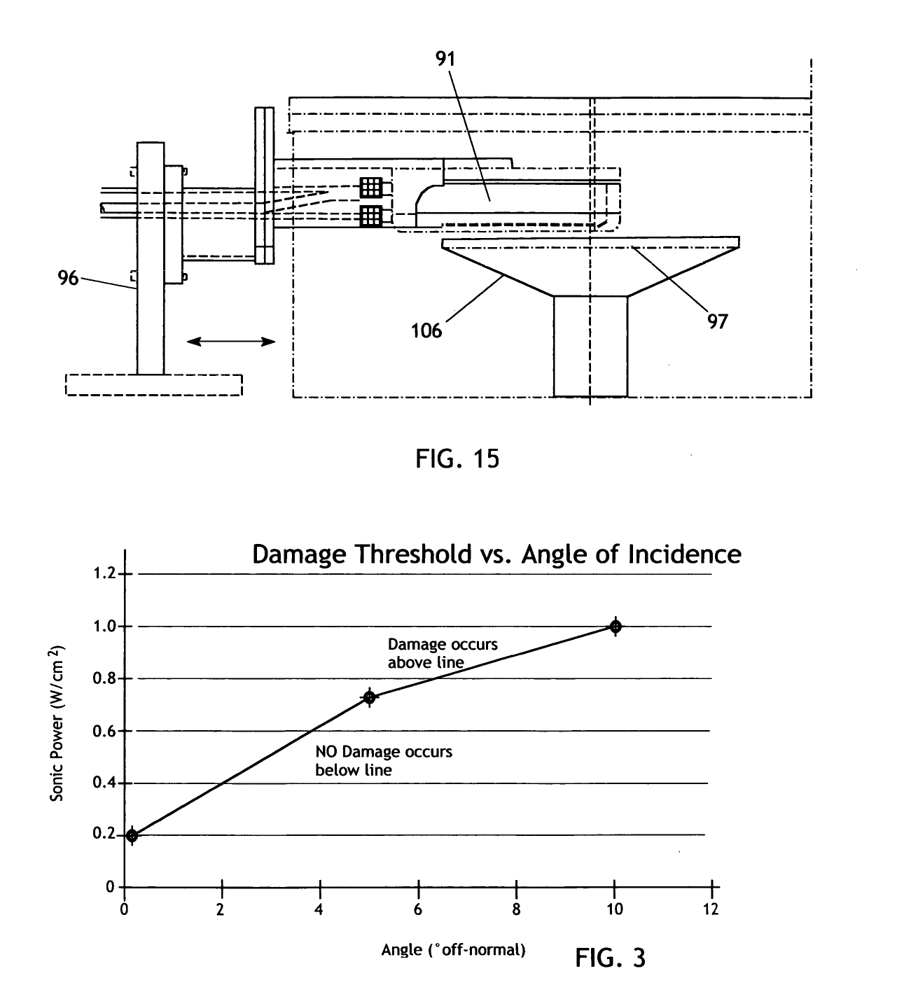

With regard to FIG. 2, the invention introduces an arrangement of the transducer 21′ with respect to the front, or active surface 23′ of the wafer 24′ in which the emitting surface 22′ is disposed at an effective angle ø with the wafer that is non-zero, and that may preferably range between 5°-30°. Expressed differently, the normal axis from the emitting surface 22′ may form an angle of 5°-30° with the normal axis from the wafer front surface 23′. This angular arrangement projecting energy toward the front surface of the wafer eliminates sonic-induced damage while cleaning ultra-sensitive semiconductor device structures having <100 nm design features. The off-normal angular relationship has the benefit of allowing cleaning with greater watt density levels of acoustic energy than with normal-incidence transducers. As shown in FIG. 3, the damage threshold as a function of sonic propagation angle for ultra-sensitive poly gate structures >80 nm was found to increase markedly with increasing propagation angle. Note for example that the damage threshold at 10° is five times the damage threshold at 0° angle (normal incidence).

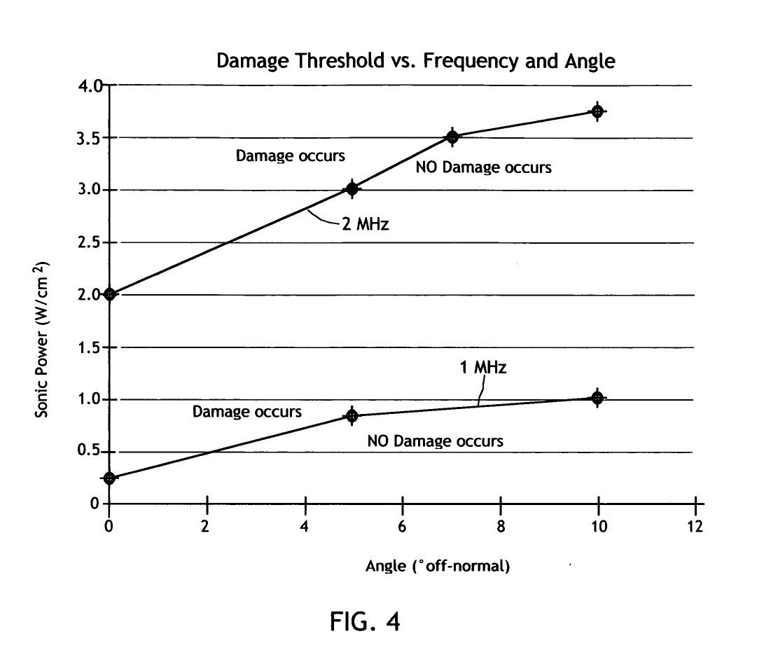

The invention further introduces the use of off-normal angle transducer design combined with higher frequency megasonic energy, in the range >1-3 Mhz. With reference to FIG. 4, it may be noted that megasonic energy at 2 MHz has a damage threshold that is several time greater than the damage threshold for megasonic energy at 1 MHz. Moreover, the damage threshold for 2 MHz energy also increases with increasing off-normal angle, showing the desirability of using 2 MHz transducers and off-normal angle incidence of the acoustic energy. That is, each innovation provides higher acoustic power density levels without damage to the wafer structures, and their combination is synergistic in further increasing the permissible power density without crossing the damage threshold.

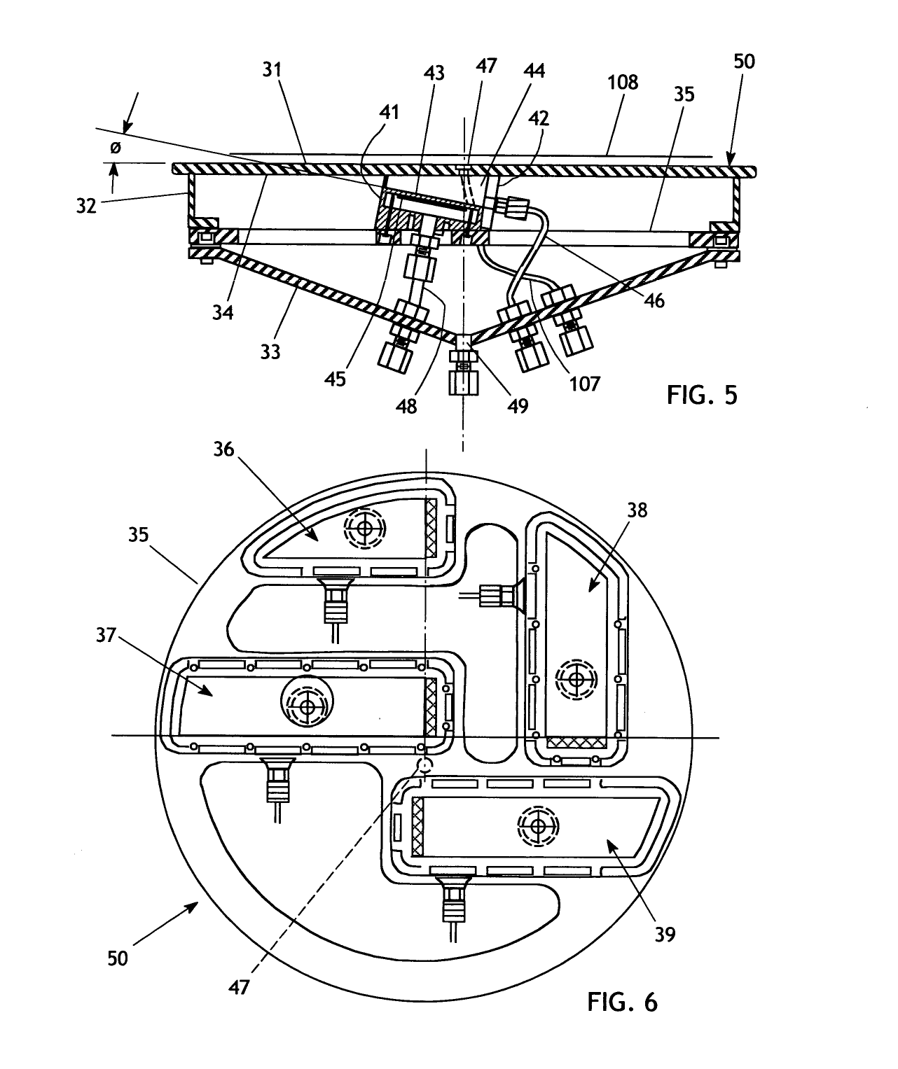

With regard to FIGS. 5-8, one embodiment of the invention includes a resonator assembly 50 that exploits the off-normal incidence angle concept of the invention. A resonator plate 31 is secured to an annular rim 32, which in turn receives a mounting plate 35 and a conical housing 33 that seals the assembly. The resonator plate 31 is coated with Teflon or a similar chemically inert material. Four transducer assemblies 36, 37, 38, and 39 are secured to the mounting plate 35. Each transducer is mounted as shown in FIG. 5, with a transducer housing 41 extending from the top of the mounting plate 35. The mounting plate 35 supports a transducer mounting plate 43, which is disposed at a predetermined angle with respect to the surface 34 and thus supports the transducer 45 at the same angle to a wafer supported directly adjacent to the upper surface of the plate 31. The mounting plate 43 together with the sidewalls 42 and surface 34 define a nearly closed fluid chamber 44 that extends between the transducer 45 and the upper surface of the plate 31. A fluid line 46 extends through the housing 33 to pump fluid into the chamber 44. The coupling fluid overflows the sidewalls 42 and exits the housing 33 at the drain 49. The fluid entirely fills the chamber 44, and the fluid-filled chamber acoustically couples the megasonic output of the transducer 45 to the boundary layer between the upper surface of the plate 31 and the wafer. A second fluid line 48 extends through the housing 33 to inject a gas into a space behind the transducer 45 to enable the fluid flow to directly cool the transducer. A process chemistry fluid delivery line 107 delivers same to the gap between wafer 108 and upper surface of the plate 31 via delivery hole 47.

The predetermined angle Ø may be in the range of 5°-30°, and may vary or be the same among the transducer assemblies 36, 37, 38, and 39. The transducer assemblies 36, 37, 38, and 39 are sized and configured and positioned in a particular pattern so that the four transducers uniformly irradiate separate portions of the plate 31 that together total a ¼ portion of the plate surface. In addition, the plate 31 is tuned to resonate at the frequency of the outputs of the transducers 45. Given the fact that the wafer diameter is generally the same as the diameter of plate 31, when the wafer is rotated in parallel, closely proximate relationship to the plate, the uniformly distributed energy of the transducer assemblies is swept across the wafer surface to irradiate the wafer surface with equal megasonic power across the entire surface. Note that the transducer assemblies are distributed about the plate 31 so that their irradiated areas do not substantially overlap, which might otherwise cause variations in the acoustic power density directed toward the wafer surface.

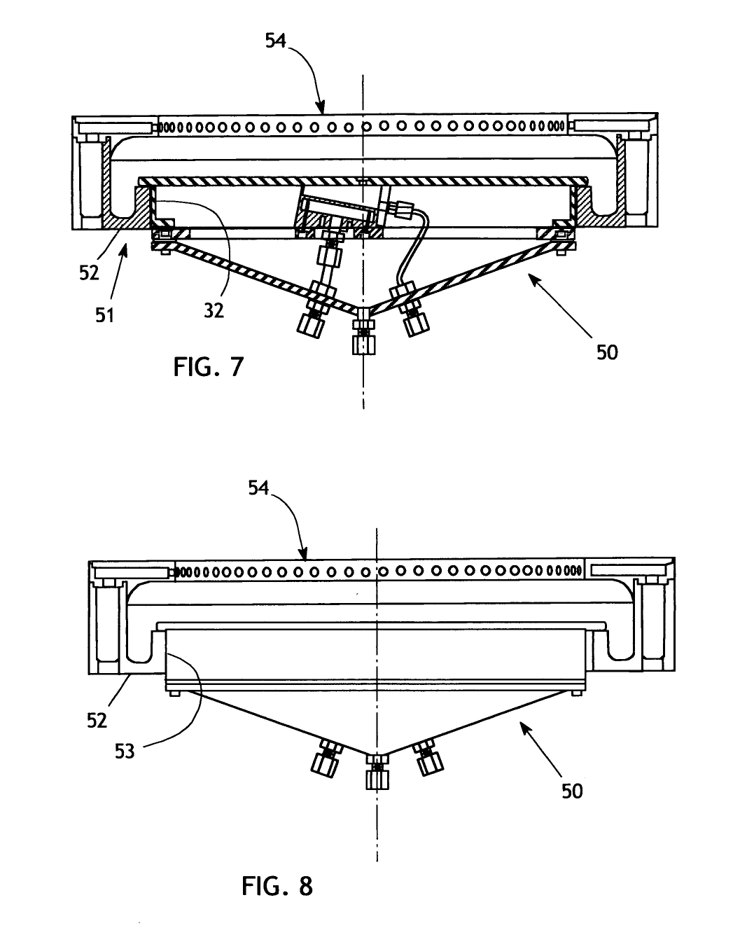

With regard to FIGS. 7 and 8, the resonator assembly 50 is supported in a chuck 51 which includes an annular member 52 having a central opening 53 dimensioned to receive the outer circumference of the rim 32. The outer periphery of the plate 31 rests on the opening 53, and the member 52 has a J configuration that forms an integral scupper for fluid used in the megasonic bath. An upper opening 54 in the assembly is dimensioned to receive therethrough a wafer disk having a diameter substantially similar to that of the plate 31 (FIG. 5). The wafer may be supported on any prior art wafer-processing arbor to be translated into close proximity (≈1 mm) to the plate 31 (FIG. 5) and rotated about the axis of the assembly to receive megasonic cleansing while fluid is pumped through the line 107 and delivery hole 47.

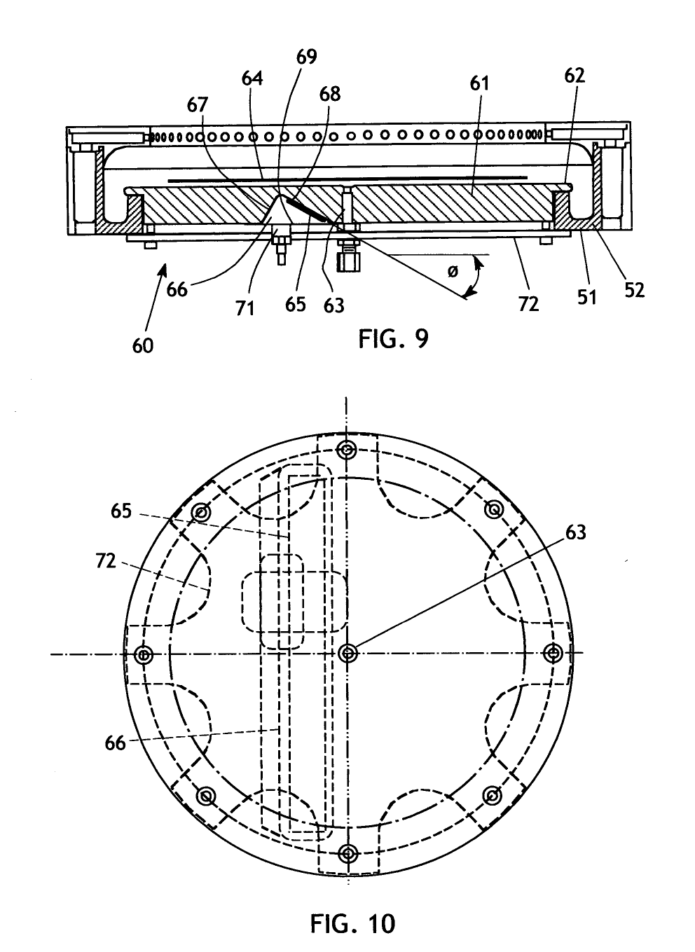

A further embodiment of the invention, shown in FIGS. 9 and 10, employs a refractive technique to deliver high power acoustic energy to a wafer in an off-normal axis direction. A resonator assembly 60 is comprised of a relatively thick cylindrical plate 61 having a flange 62 that engages the end of the annular member 52 of chuck 51, while the plate 61 is received through the opening 53 (not shown in FIG. 9 or 10) of the chuck. The plate includes a central fluid port 63 for pumping a fluid stream into contact with a wafer disk 64 in close proximity to the upper surface of the plate. A channel 66 extends in the bottom surface of the plate 61, the channel 66 being offset from a diameter of the plate and extending substantially the entire length of a chord of the plate. The channel 66 is formed by two planar side walls 67 and 68 extending at a mutually orthogonal relationship. A transducer 65 is mounted on side wall 68 and extends substantially the length thereof, the transducer being disposed in a non-parallel relationship to the upper surface of the plate 61. A cover plate 69 partially covers the length of the channel 66. An RF connector 71 supplies electrical energy to the piezo transducers. A mounting plate 72 is bolted to the plate 61 at the periphery to secure the assembly 60 to the chuck 51.

A key factor in the construction of resonator assembly 60 is that the transducer 65 is disposed at an angle Ø with respect to the upper surface of the plate 61. The plate is formed of an acoustically transmissive material, such as solid aluminum, (other materials can also be used, such as graphite, SiC coated graphite, SiC, Quartz, Stainless Steel, etc) through which the megasonic energy has a velocity that differs from its velocity in the fluid or solvent, or in silicon. As a result, the acoustic energy radiated from transducer 65 is refracted at the upper surface of the plate 61 to impinge on the wafer 64 at an angle less than Ø. For example, if Ø≈30°, the angle of incidence at the wafer 64 is approximately 7° (±2°), while the upper surface of the plate and the wafer are parallel. This effect is achieved with the transducer being directly bonded to the resonator plate for maximum acoustic energy conduction. The off-normal incidence angle reduces sonic induced damage to ultra-sensitive structures in the wafer, and permits the application of greater acoustic power density to the wafer for cleaning purposes. A single transducer mounted near the diameter of the plate is adequate to sonically activate the entire surface of the wafer from center to edge while the wafer rotates. Note that the entire assembly may be inverted with the wafer below the resonator without adversely affecting the performance of the components.

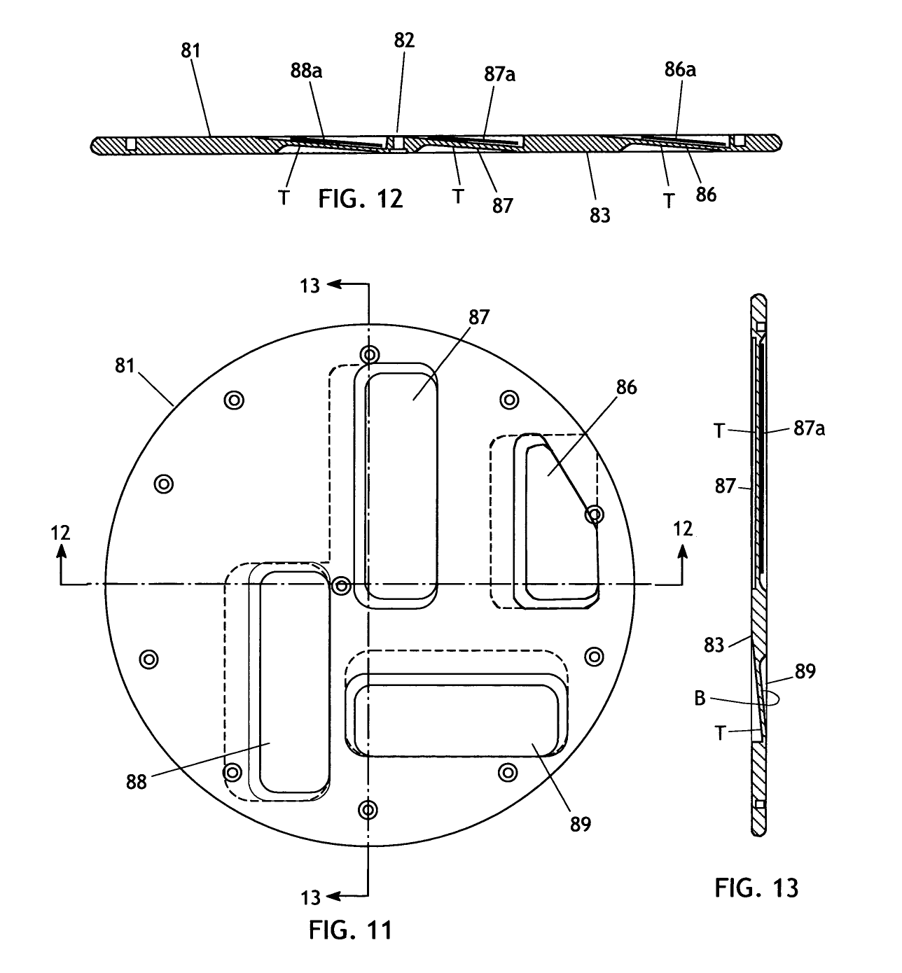

With reference to FIGS. 11-13, another implementation of the off-normal axis incidence concept includes a resonator plate 81 adapted to be secured in a chuck substantially as described previously. The plate 81 comprises a disk having a fluid port 82 close to the center thereof for pumping fluid or solvent toward a wafer held proximate to the outer surface 83 of the plate. A significant aspect of the plate 81 is the provision of four parallel lenticular resonator areas 86, 87, 88 and 89. The resonator areas 86, 87, 88 and 89 are sized and configured and positioned in a particular pattern so that the four transducers uniformly irradiate separate portions of the plate 31 that together total a ¼ portion of the plate surface, and have configurations similar to the transducer assemblies of the resonating assembly of FIGS. 5 and 6. Each resonator area is formed by parallel top and bottom surfaces T and B of the plate that are parallel to each other and angularly offset from the plane of the plate 81. Transducers 86a-89a are bonded to the bottom surface B of each parallel lenticular resonator area 86, 87, 88 and 89, respectively, to drive each parallel lenticular area to radiate acoustic energy at an angle that is offset from normal by approximately 5° (range between 5°-10°).

Direct bonding of the transducers 86a-89a maximizes the transmission of acoustic energy through the plate to the adjacent wafer undergoing processing. The off-normal angle of incidence minimizes or eliminates damage to semiconductor structures within the wafer, and permits the use of higher acoustic power density for more thorough cleaning. The plate may be formed of aluminum, with the outer surface smooth and radiused and coated with Teflon or similar chemically inert material. It may be appreciated that the invention includes combining the concepts of the prior two embodiments, i.e., the parallel lenticular plate as just described, together with the single row transducer in the “30-7” concept in order to take advantage of the benefits of both innovations

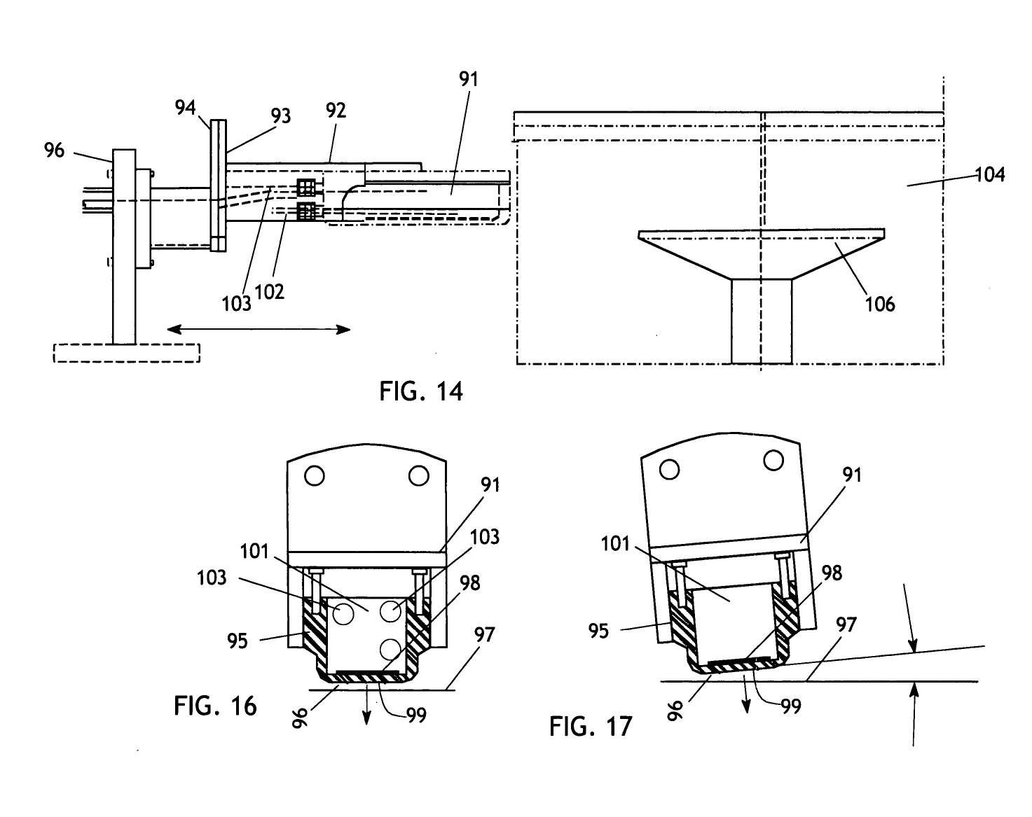

With regard to FIGS. 14 and 15 there is shown a further embodiment of the invention for megasonic cleaning using off-normal axis acoustic energy. A megasonic resonator assembly 91 is supported at the distal end of an arm 92 that extends from a bracket 93. The bracket 93 is secured to a mount 94 of a carriage assembly 96 that is adapted to translate reciprocally in the direction shown by the double-ended arrow. The bracket 93 and mount 94 is angularly adjustable about an axis extending horizontally through the bracket and mount. The resonator assembly 91, as shown in FIG. 16, includes a housing 95 having a generally flat output surface 96 that is adapted to be disposed closely proximate to a wafer 97. Within the assembly 91 there is a transducer 98 bonded directly to a thin-walled portion 99 of a fluid-filled cavity 101. RF energy is delivered to the transducer at the coax fitting 102. The transducer emits megasonic energy outwardly along a normal axis, as shown in FIG. 16. A pair of fluid supply lines 103 extend from the carriage assembly 96 to the cavity 101 to supply and recover cooling fluid, which may comprise either CDA (clean dry air) or N₂.

The carriage assembly 96 cooperatively interacts with a cleaning tank 104 in which a chuck assembly 106 supports a rotatable wafer 97. The carriage assembly may translate into engagement with the tank, as shown in FIG. 15, so that the resonator assembly 91 is directly superjacent to the wafer 97. As shown in FIG. 17, the resonator assembly 91 may be rotated through a range of 0°-10° about the axis of mount 94 to offset the output axis of the transducer 98 from an orthogonal relationship with the wafer 97. This off-normal angle of incidence reduces or eliminates sonic-induced damage and permits the user of higher acoustic energy density in the megasonic cleaning process. The carriage may be translated while the resonator assembly is operating to scan the resonator output across the surface of the wafer 97 from periphery to center or vice versa. The scan movement rate may be adjusted to compensate for variations in acoustic power density as the resonator assembly 91 moves along the radius of the wafer, given that the swept area varies with the square of the radius of the rotating wafer.

The embodiment of FIGS. 14-17 take advantage of the direct bonding of the transducer to the resonator housing for maximum acoustic transmission. The propagation angle is adjustable from 0°-10° off normal to reduce or eliminate sonic-induced damage to semiconductor structures in the wafer. The moving carriage also permits rapid exchange of chemistry and water for very rapid sonic cleaning and rinsing.

The concept of beaming megasonic energy at a non-normal angle to a surface undergoing cleaning may be extended to batch cleaning of wafers. One or more transducers may be disposed in a batch processing tank in which a plurality of wafers are immersed while being supported in a cassette or the like. The transducer(s) may be mounted on the sides and/or bottom of the tank and directed to radiate megasonic energy at an oblique angle to the surfaces of the wafers.

It is noted that the transducers references herein are flat panel devices, such as piezoelectric devices and the like. In the description above, the transducer is described as parallel to a surface or element when the plane of the flat panel device is parallel to the surface or element. Likewise, the description of an axis normal to the transducer is taken to indicate normal to the plane of the flat panel device. Also, typical wafers employed in semiconductor processing are circular disks having diameters in the range of 100-300 mm, and the resonator plates described herein are similarly configured as circular structures having a diameter appropriately similar to the wafer being processed.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. Apparatus for megasonic bath cleaning of a wafer, including:
a resonator plate having a smooth outer surface and an axis normal to said outer surface and adapted to radiate megasonic energy outwardly along an output axis that diverges from said normal axis;
means for supporting a wafer in close proximity and parallel to said outer surface of said resonator plate, whereby said megasonic energy impinges on said wafer in a non-normal angular relationship.

2. The apparatus of claim 1, wherein said output axis diverges from said normal axis by an angle Ø, and Ø is in the range of 0°-30°.

3. The apparatus of claim 1, further including at least one acoustic transducer joined to an inner surface of the resonator plate.

4. The apparatus of claim 3, further including means for mounting said least one transducer on said inner surface at a non-parallel angle to said outer surface.

5. The apparatus of claim 4, wherein said means for mounting includes a slot formed in said inner surface of said resonator plate, said slot having a sidewall disposed at said non-parallel angle to said outer surface, said transducer being joined to said sidewall.

6. The apparatus of claim 4, further including a transducer housing for supporting said transducer on said inner surface of said resonator plate.

7. The apparatus of claim 6, wherein said transducer housing includes a closed fluid chamber bounded on one side by said inner surface of said resonator plate.

8. The apparatus of claim 7, wherein said closed fluid chamber is bounded on another side by a sidewall, and said transducer is secured to said sidewall.

9. The apparatus of claim 8, wherein said sidewall extends at a non-parallel angle to said outer surface, and said closed fluid chamber couples the acoustic output of said transducer to said resonator plate at an angle off-normal to said outer surface of said resonator plate.

10. The apparatus of claim 7, further including means for circulating fluid through said closed fluid chamber to cool said transducer.

11. The apparatus of claim 3, further including a plurality of acoustic transducers joined to the inner surface of the resonator plate, said plurality of transducers each irradiating a respective portion of said resonator plate.

12. The apparatus of claim 11, wherein said acoustic transducers are distributed about said resonator plate in a pattern so that the separately irradiated respective portions of said resonator plate additively comprise a pie-piece shaped portion of said outer surface of said resonator plate.

13. The apparatus of claim 12, wherein said means for supporting said wafer include means for rotating said wafer parallel to said outer surface of said resonator plate, whereby said pie-piece shape portion scans the surface of said wafer and uniformly irradiates said wafer surface.

14. The apparatus of claim 12, wherein each of said respective portions of said resonator plate comprises a respective lenticular resonator area of said resonator plate.

15. The apparatus of claim 14, wherein each lenticular resonator area includes parallel top surface and bottom surface portions of said resonator plate that are angularly offset from said outer surface of said resonator plate.

16. The apparatus of claim 15, further including a plurality of transducers, each bonded to one of said bottom surface portions of a respective lenticular resonator area.

17. The apparatus of claim 1, further including fluid output port means in said resonator plate to direct a fluid stream toward said wafer.

18. The apparatus of claim 3, further including acoustic refracting means joined between said at least one acoustic transducer and said outer surface of said resonator plate.

19. The apparatus of claim 1, wherein said megasonic energy is directed toward the front, active surface of said wafer in a non-normal angular relationship.

20. Apparatus for megasonic bath cleaning of a wafer, including:
a resonator plate having a smooth outer surface and adapted to radiate megasonic energy outwardly along an output axis;
carriage means for supporting said resonator plate, said carriage means adapted for reciprocal translation from a first position in which said resonator plate is disengaged from said wafer, to a second position in which said resonator plate is in close proximity to a surface of said wafer;
angle adjustment means for selectively orienting said resonator plate with said output axis of said resonator plate disposed in an off-normal angle of incidence to said surface of said wafer.

21. The apparatus of claim 20, wherein said angle adjustment means includes an arm extending from said carriage means to said resonator plate.

22. The apparatus of claim 21, further including a resonator assembly in which said resonator plate is supported.

23. The apparatus of claim 22, wherein said resonator assembly includes a gas chamber impinging on said resonator plate.

24. The apparatus of claim 23, further including means for circulating cooling gas through said fluid chamber.

25. The apparatus of claim 20, wherein said output axis is directed generally downwardly toward said surface of said wafer.

26. The apparatus of claim 20, further including means for rotating said wafer in close proximity to said resonator plate.

27. The apparatus of claim 26, wherein said carriage means is translatable while said resonator plate is radiating megasonic energy, whereby said megasonic energy is scanned across said surface of said rotating wafer.

28. The apparatus of claim 20, wherein said megasonic energy is directed toward the front, active surface of said wafer.

29. Apparatus for megasonic bath cleaning of a wafer, including:
a resonator plate having a smooth outer surface and an axis normal to said outer surface and adapted to radiate megasonic energy outwardly along an output axis that diverges from said normal axis by an angle Ø in the range of 5°-30°;
means for supporting a wafer in close proximity and parallel to said outer surface of said resonator plate, whereby said megasonic energy impinges on said wafer in a non-normal angular relationship;
said megasonic energy being in the frequency range of 0.6 Mhz-10 MHz.

30. A method for megasonic bath cleaning of a wafer, including:
providing a resonator plate adapted to radiate megasonic energy outwardly along an output axis;
supporting a wafer in close proximity and parallel to said outer surface of said resonator plate, said megasonic energy impinging on said wafer in an off-normal axis angle of incidence.

31. The method of claim 30, further including the step of mounting at least one acoustic transducer on said resonator plate with said acoustic transducer in non-parallel alignment with said resonator plate.

32. The method of claim 31, further including the step of providing at least one lenticular resonator area in said resonator plate, said acoustic transducer being joined to said lenticular resonator area.

33. The method of claim 31, further including the step of providing an acoustic refractor structure between said acoustic transducer and said resonator plate.

34. The method of claim 31, further including the step of providing a plurality of acoustic transducers joined to an inner surface of the resonator plate, said plurality of transducers each irradiating a respective portion of said resonator plate.

35. The method of claim 34, further including the step of distributing said acoustic transducers about said resonator plate in a pattern so that the separately irradiated respective portions of said resonator plate additively comprise a pie-piece shaped portion of said outer surface of said resonator plate that receives equal and uniform acoustic power density.

36. The method of claim 35, further including the step of rotating the wafer to scan said pie-piece shaped irradiation pattern about the surface of the wafer.

37. The method of claim 308, including the step of providing a carriage to support said resonator plate for translation into and out of engagement with the wafer.

38. The method of claim 37, further including providing an angular adjustment mount on said carriage to selectively align said resonator plate in said off-normal axis angle of incidence.

39. The method of claim 30, further including the step of directing said megasonic energy toward the front, active surface of said wafer.
